(19) United States
(12) Patent Application Publication
(10) Pub. No.: US 2007/0073878 A1
(43) Pub. Date: Mar. 29, 2007

(54) System and method for lowering proxy bandwidth utilization

(75) Inventor: Alfredo C. Issa, Apex, NC (US)

Correspondence Address: WITHROW & TERRANOVA, P.L.L.C., P.O. BOX 1287, CARY, NC, 27512, US

(73) Assignee: QURIO HOLDINGS, INC., Peterborough, NH (US)

(21) Appl. No.: 11/234,493

(22) Filed: Sep. 23, 2005

(51) Int. Cl. G06F 15/173

(52) U.S. Cl. 709/225

(57) ABSTRACT

A hybrid peer-to-peer network that lowers proxy bandwidth utilization is provided. The peer-to-peer network includes peer nodes, a proxy server, and one or more guest nodes. To initiate a transfer of digital content residing on a peer node, a requesting node, which may be another peer node or a guest node, sends an HTTP request to the proxy server. The proxy server determines whether the requested digital content is bandwidth rich content such as digital images, video, or audio. If so, the proxy server generates a URL for the digital content and sends an HTTP redirect message. The requesting node then generates a second HTTP request based on the HTTP redirect message and sends the second HTTP request to the peer node. In response, the peer node generates an HTTP response including the requested digital content and sends the HTTP response to the requesting node.

### FIELD OF THE INVENTION

The present invention relates to a peer-to-peer network for sharing digital content and more particularly relates to lowering bandwidth utilization of a proxy server in the peer-to-peer network by by-passing the proxy server when transferring bandwidth rich digital content.

### BACKGROUND OF THE INVENTION

With the proliferation of digital cameras, numerous online photosharing services have emerged and are becoming widely accepted by photo enthusiasts. The photosharing services are generally based on one of two architectures. The first is a serving architecture where a central server hosts digital images for a number of users and provides photosharing services by serving the digital images to a web browser of a user or guest. The second is a peer-to-peer (P2P) architecture, such as that used by QURIO photosharing software, where a user creates and stores photo albums on the user's computer. The user's computer then operates as a web server to provide the photo albums to the web browser of another user or guest.

One issue with the P2P architecture is that the peer nodes, or web servers, may be located behind firewalls and have dynamic Internet Protocol (IP) addresses. One solution to this problem is a hybrid P2P architecture such as that described in U.S. patent application Ser. No. 10/813,839, entitled METHOD AND SYSTEM FOR PROVIDING WEB BROWSING THROUGH A FIREWALL IN A PEER TO PEER NETWORK, filed on Mar. 31, 2004, currently pending, which is hereby incorporated by reference in its entirety. In the hybrid P2P architecture, a proxy server is used to direct traffic between a peer node providing digital content and another peer node or guest node requesting the digital content. More specifically, a peer node registers an outbound socket connection with the proxy server, and all requests for digital content from the peer node are directed to the proxy server. When the proxy server receives a Hypertext Transfer Protocol (HTTP) request for digital content residing on the peer node, the proxy server translates the HTTP request into a proprietary request packet, hereafter referred to as a request packet or more generally as a request message, and sends the request packet to the peer node via the socket connection. The peer node converts the request packet to an HTTP request and provides the HTTP request to a web server at the peer node. In response, the web server generates an HTTP response, which is converted to one or more response packets. The response packets are sent to the proxy server via the socket connection, where they are converted into an HTTP response. The proxy server then provides the HTTP response to the web browser at the requesting node.

One issue with the hybrid P2P architecture is that all traffic flows through the proxy server. As the number of peer nodes increases and the digital content transferred by the peer nodes becomes more bandwidth rich, which is the case for digital images, digital video, and digital audio, the bandwidth utilization of the proxy server may become very high. As such, there remains a need for a system and method for lowering the bandwidth utilization of a proxy server.

### SUMMARY OF THE INVENTION

The present invention provides a hybrid peer-to-peer network that lowers proxy bandwidth utilization. In general, the peer-to-peer network includes peer nodes, a proxy server, and one or more guest nodes. To initiate a transfer of digital content residing on a peer node, a requesting node, which may be another peer node or a guest node, sends a Hypertext Transfer Protocol (HTTP) request to the proxy server. The proxy server determines whether the requested digital content is bandwidth rich content such as digital images, video, or audio. If the proxy server determines that the requested digital content is bandwidth rich content, then the proxy server generates a Uniform Resource Locator (URL) for the digital content at the peer node and sends an HTTP redirect message including the URL for the digital content at the peer node to the requesting node. The requesting node then generates a second HTTP request based on the HTTP redirect message from the proxy server and sends the second HTTP request to the peer node. In response to receiving the second HTTP request, the peer node generates an HTTP response including the requested digital content and sends the HTTP response to the requesting node. As such, the transfer of the digital content from the peer node to the requesting node by-passes the proxy server, thereby lowering the bandwidth utilization of the proxy server.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates an exemplary hybrid peer-to-peer system according to the present invention;

FIG. 2 illustrates an exemplary transfer of non-bandwidth rich content according one embodiment of the present invention;

FIG. 3 illustrates an exemplary transfer of bandwidth rich content according to one embodiment of the present invention;

FIG. 4 is a flow chart illustrating the operation of the proxy server of FIG. 1 according to one embodiment of the present invention;

FIG. 5 is a flow chart illustrating the operation of the peer node of the FIG. 1 according to one embodiment of the present invention;

FIG. 6 illustrates an exemplary transfer of bandwidth rich content according to another embodiment of the present invention;

FIG. 7 is a flow chart illustrating the operation of the proxy server of FIG. 1 according to the embodiment of the present invention illustrated in FIG. 6;

FIG. 8 is a flow chart illustrating the operation of the peer node of FIG. 1 according to the embodiment of the present invention illustrated in FIG. 6;

FIG. 9 is a basic block diagram of an exemplary embodiment of the proxy server of FIG. 1; and

FIG. 10 is a basic block diagram of an exemplary embodiment of the peer node of FIG. 1.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention provides a hybrid peer-to-peer system that lowers proxy bandwidth utilization. In general, the proxy server examines a Hypertext Transfer Protocol (HTTP) request for digital content residing at a peer node. If the digital content is bandwidth rich content such as a digital image, video, or audio, then the proxy server sends an HTTP redirect message including the Uniform Resource Locator (URL) of the digital content at the peer node. Using the HTTP redirect message, the requesting node requests the digital content directly from the peer node. In response, the peer node provides the digital content to the requesting node such that the transfer of the digital content from the peer node to the requesting node by-passes the proxy server.

Although the description herein describes the present invention with respect to a peer-to-peer network, the present invention is equally applicable to any system where digital content is provided from a web server to a requesting node via a proxy server. It should also be noted that, as described herein, the preferred embodiment of the present invention is implemented using the HTTP protocol and URLs. However, as will be apparent to one of ordinary skill in the art upon reading this disclosure, other protocols and resource locators currently existing or created in the future may be used to implement the present invention.

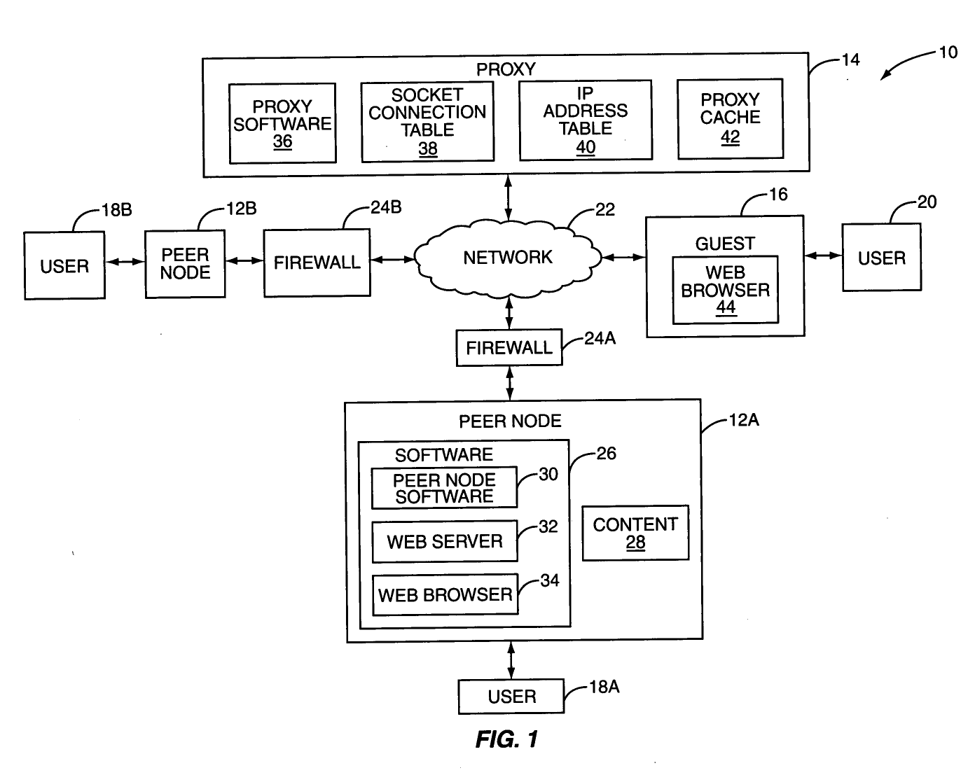

FIG. 1 illustrates an exemplary hybrid peer-to-peer (P2P) system 10 according to one embodiment of the present invention. The hybrid P2P system 10 includes peer nodes 12A and 12B, a proxy server 14, guest node 16, users 18A and 18B, user 20 associated with the guest node 16, and network 22. Preferably, the network 22 is the Internet. There may be any number of peer nodes 12A, 12B and guest nodes 16.

In general, the peer nodes 12A and 12B, which may also be referred to herein as web serving nodes, are personal computers, mobile terminals, Personal Digital Assistants, or the like having access to the network 22. In this embodiment, peer nodes 12A and 12B are connected to the network 22 through firewalls 24A and 24B. The firewalls 24A and 24B may be hardware and/or software residing in routers interconnecting the peer nodes 12A and 12B to the network 22. Alternatively, the firewalls 24A and 24B may be hardware and/or software residing in the peer nodes 12A and 12B. Note that there may be additional peer nodes in the hybrid P2P system 10 that are not located behind firewalls.

As illustrated, the peer node 12A includes software 26 and digital content 28. It should be noted that the discussion herein of the peer node 12A is equally applicable to the peer node 12B. The software 26 includes peer node software 30, a web server 32, and optionally a web browser 34. The digital content 28 may be a digital image, a digital video, digital audio, a graphic, text, html code, or the like. Although only the digital content 28 is illustrated, the peer node 12A may include additional digital content, as will be apparent to one having ordinary skill in the art upon reading this disclosure. The proxy server 14, which may also be referred to as a central node, includes proxy software 36, a socket connection table 38, an Internet Protocol (IP) address table 40, and optionally proxy cache 42. The guest node 16 is also a personal computer, mobile terminal, Personal Digital Assistant, or the like having access to the network 22 and preferably includes a web browser 44.

The hybrid P2P system 10 of the present invention operates to transfer the digital content 28 from the peer node 12A to a requesting node, which is either another peer node such as the peer node 12B or the guest node 16. If the digital content 28 is non-bandwidth rich content, the digital content 28 is transferred to the requesting node through the proxy server 14. If the digital content 28 is bandwidth rich content, the proxy server 14 is by-passed such that the digital content 28 is transferred directly from the peer node 12A to the requesting node, thereby by-passing the proxy server 14. It should be noted that, although the description herein focuses on by-passing the proxy server 14 based on bandwidth rich content, other criteria may be used to determine when to by-pass the proxy server 14, as will be apparent to one of ordinary skill in the art upon reading this disclosure.

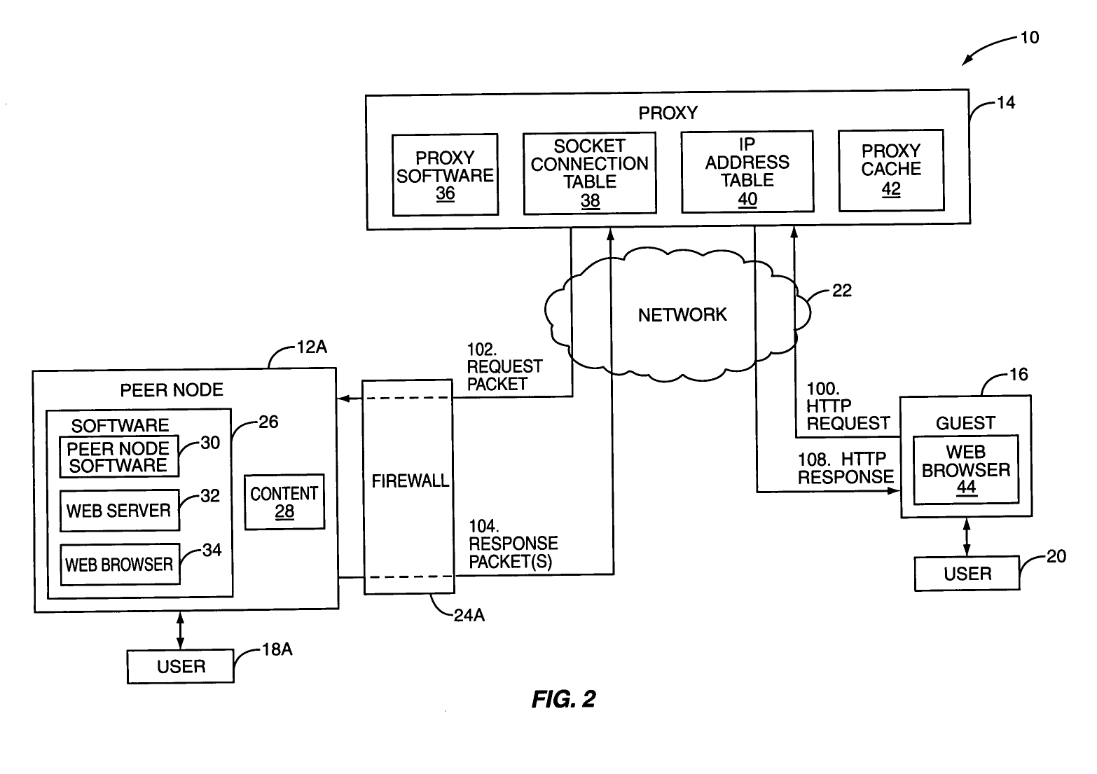

FIG. 2 illustrates a transfer of non-bandwidth rich content. When the peer node 12A comes online by either connecting to the network 22 or by enabling the peer node software 30, the peer node 12A establishes a socket connection with the proxy server 14. The proxy server 14 stores information identifying the socket connection and associating the socket connection with the peer node 12A in the socket connection table 38. The transfer of non-bandwidth rich content begins when an HTTP request for the digital content 28 is generated by the web browser 44 at the guest node 16 and sent to the proxy server 14 (step 100).

The proxy server 14 determines whether the HTTP request is for bandwidth rich content or non-bandwidth rich content. In one embodiment, the proxy server 14 determines whether the digital content 28 requested by the requesting party is bandwidth rich content by examining the URL of the HTTP request or examining the standard Multipurpose Internet Mail Extension (MIME) type included in the HTTP request to determine a file type of the digital content 28. If the file type of the digital content 28 is one of a predetermined set of file types that are determined to be bandwidth rich content, then the proxy server 14 determines that the digital content 28 is bandwidth rich content. For example, if the URL of the requested digital content 28 ends with “.jpg” or like digital image file extension, “.mpg” or like digital video extension, or “.mp3” or like digital audio extension, then the proxy server 14 determines that the digital content 28 requested is bandwidth rich content. On the other hand, if the URL of the requested digital content 28 ends with “.html”, “.txt”, or the like, the proxy server 14 determines that the requested digital content 28 is non-bandwidth rich content.

In a similar fashion, the MIME type in the header of the HTTP request attempts to identify the type of content of the requested digital content 28 and may be used to determine whether the HTTP request is for bandwidth rich content. Thus, in essence, the proxy server 14 determines the type of digital content 28 requested. If it is a file type that typically has a large file size, such as a digital image, digital video, or digital audio file type, the proxy server 14 determines that the requested digital content is bandwidth rich content. Otherwise, the proxy server 14 determines that the requested digital content is non-bandwidth rich content.

In another embodiment, the proxy server 14 communicates with the peer node 12A via the socket connection to determine whether the digital content 28 is bandwidth rich content. As a first example, the proxy server 14 may request the file size of the digital content 28 from the peer node 12A. If the file size is greater than a predetermined threshold such as 2 MB, 5 MB, 10 MB, or the like, then the digital content 28 is bandwidth rich content. Otherwise, the digital content 28 is not bandwidth rich content. As a second example, the proxy server 14 may request the file type of the digital content 28 from the peer node 12A and determine whether the digital content 28 is bandwidth rich content based on the file type, as described above. As a third example, the proxy server 14 may request both the file size and file type of the digital content 28 from the peer node 12A and determine whether the digital content 28 is bandwidth rich based on both the file size and file type. As yet another example, the proxy server 14 may request that the peer node 12A determine whether the digital content 28 is bandwidth rich content. In response, the peer node 12A may determine whether the digital content 28 is bandwidth rich content based on the file size and/or file type of the digital content 28. Further, in each of these examples, other factors may be used to determine whether the digital content 28 is bandwidth rich content, as will be apparent to one of ordinary skill in the art upon reading this disclosure.

Referring again to FIG. 2, the proxy server 14 determines that the requested digital content 28 is non-bandwidth rich content. As such, the proxy server 14 translates the HTTP request into a proprietary request packet, which is hereafter referred to as a request packet. The request packet may more generally be referred to as a request message. Using the socket connection table 38, the proxy server 14 finds the socket connection that connects the peer node 12A to the proxy server 14. The proxy server 14 then sends the request packet to the peer node 12A via the socket connection (step 102).

In response to receiving the request packet from the proxy server 14, the peer node 12A, and particularly the peer node software 30, converts the request packet into an HTTP request and provides the HTTP request to the web server 32. In response to the HTTP request, the web server 32 generates an HTTP response including the requested digital content 28. The peer node software 30 converts the HTTP response into one or more response packets and sends the response packets to the proxy server 14 via the socket connection (step 104). The proxy server 14 then converts the response packets from the peer node 12A into an HTTP response and sends the HTTP response to the web browser 44 at the guest node 16 (step 106). Optionally, the proxy server 14 may store all or a portion of the digital content 28 in the proxy cache 42. Thereafter, when a subsequent request is received for the digital content 28, all or a portion of the digital content 28 may be served from the proxy cache 42.

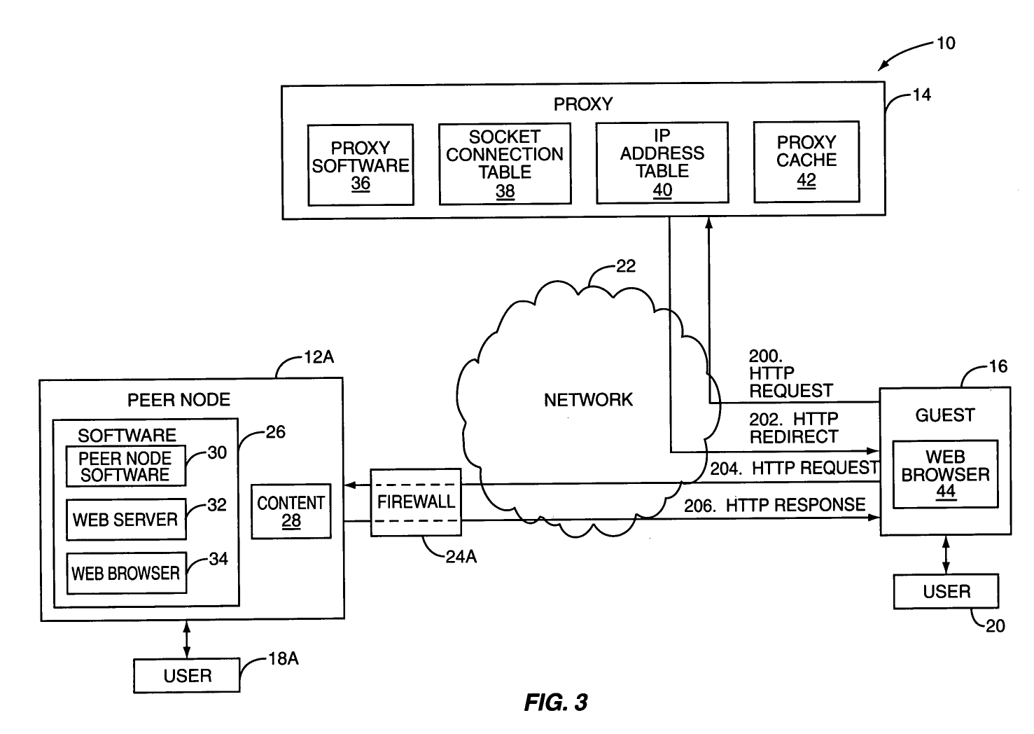

FIG. 3 illustrates a transfer of the digital content 28 from the peer node 12A to the guest node 16 when the digital content 28 is bandwidth rich content. Prior to the transfer, the peer node 12A sends its IP address to the proxy server 14 via the socket connection, and the proxy server 14 stores the IP address of the peer node 12A in the IP address table 40. Since the IP address of the peer node 12A may dynamically change, the peer node 12A preferably sends the IP address of the peer node 12A to the proxy server 14 periodically. In one embodiment, the peer node 12A sends its IP address to the proxy server 14 periodically along with a keep-alive ping request.

The transfer begins when an HTTP request for the digital content 28 is generated by the web browser 44 at the guest node 16 and sent to the proxy server 14 (step 200). The proxy server 14 determines whether the HTTP request is for bandwidth rich content, as discussed above. In this example, the proxy server 14 determines that the requested digital content 28 is bandwidth rich content. As such, the proxy server 14 determines the IP address of the peer node 12A using the IP address table 40 and constructs a URL for the requested digital content 28 at the peer node 12A. The proxy server 14 then sends the URL for the requested digital content 28 to the guest node 16 as an HTTP redirect message (step 202). Upon receiving the HTTP redirect message, the web browser 44 at the guest node 16 generates a new HTTP request using the URL in the HTTP redirect message from the proxy server 14 and sends the HTTP request to the peer node 12A (step 204).

In response to receiving the HTTP request from the guest node 16, the peer node 12A, and particularly the peer software 30, may perform some type of security checking to determine if the HTTP request is a valid request. The peer software 30 then passes the HTTP request to the web server 32. In response, the web server 32 generates an HTTP response including the requested digital content 28. The HTTP response is then provided to the guest node 16 (step 206), thereby completing the transfer.

In order for the HTTP request to be directed to the peer node 12A to allow proxy by-passing, the firewall 24A is configured to allow HTTP requests on a desired port, such as port 80. The firewall 24A may be configured manually by the user 18A. Alternatively, the firewall 24A may automatically be configured by the peer node software 26 using Universal Plug and Play or the like.

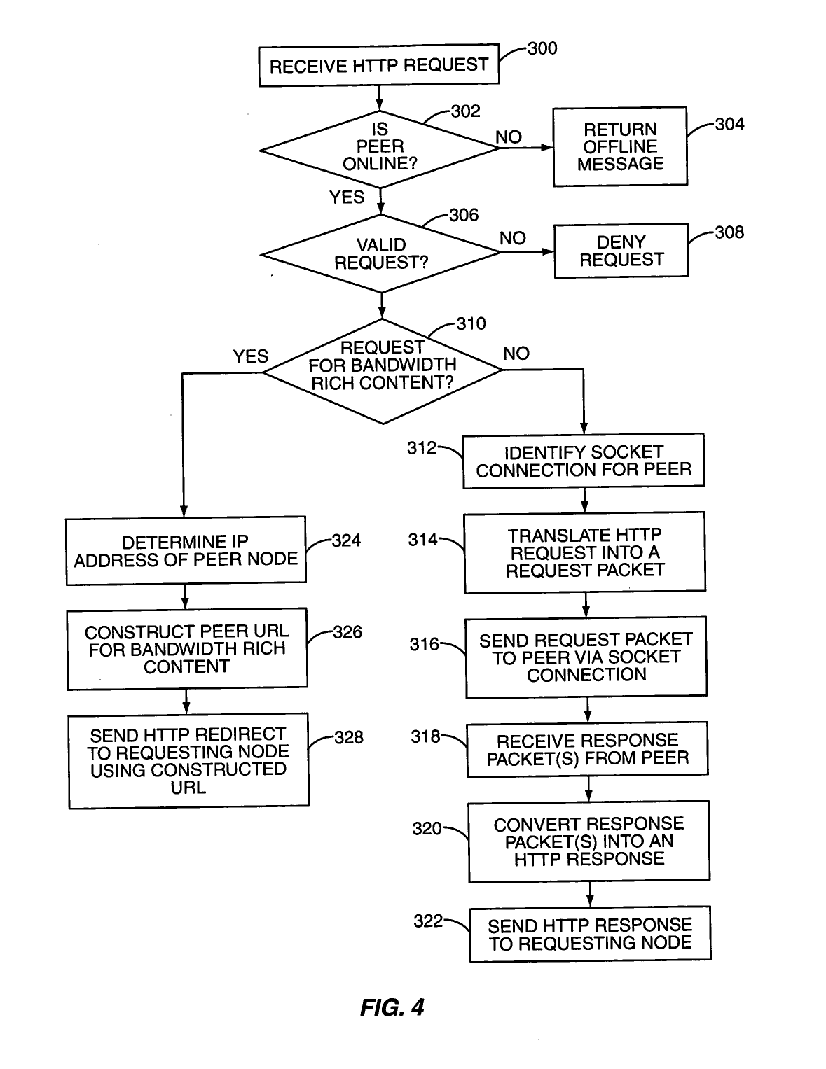

FIG. 4 is a flow chart illustrating the operation of the proxy server 14 according to one embodiment of the present invention. In general, the proxy server 14 first receives an HTTP request from a requesting node (step 300). Note that prior to receiving the HTTP request at the peer server 14, the peer node 12A establishes a socket connection with the proxy server 14 and provides its IP address to the proxy server 14, as discussed above.

After receiving the HTTP request, the proxy server 14 determines if the peer node 12A associated with the digital content 28 requested by the HTTP request is currently online (step 302). If the peer node 12A is not online, then the proxy server 14 returns an offline message to the requesting node (step 304). If the peer node 12A is currently online, then the proxy server 14 determines whether the HTTP request is a valid request (step 306). The HTTP request may be invalid if the HTTP request is for digital content that is not associated with the hybrid P2P system 10. More specifically, if the HTTP request is for content other than the digital content 28, which the user 18A has permitted the peer node software 30 to share, then the request is invalid. If the HTTP request is not valid, then the request is denied (step 308).

If the HTTP request is valid, then the proxy server 14 determines whether the HTTP request is for bandwidth rich content, as described above (step 310). If the HTTP request is for digital content 28 that is not bandwidth rich content, then the proxy server 14 identifies the socket connection that connects the peer node 12A to the proxy server 14 using the socket connection table 38 (step 312), translates the HTTP request into a request packet (step 314), and sends the request packet to the peer node 12A via the socket connection (step 316). Thereafter, the proxy server 14 receives response packets from the peer node 12A (step 318), converts the response packets into an HTTP response (step 320), and sends the HTTP response to the requesting node (step 322).

If the HTTP request is for digital content 28 that is bandwidth rich content, then the proxy server 14 determines the IP address of the peer node 12A (step 324), constructs a URL for the bandwidth rich digital content 28 (step 326), and sends an HTTP redirect message to the requesting node using the constructed URL (step 328). Then, as discussed above, the requesting node uses the HTTP redirect message to send an HTTP request directly to the peer node 12A to obtain the bandwidth rich digital content 28, thereby by-passing the proxy server 14.

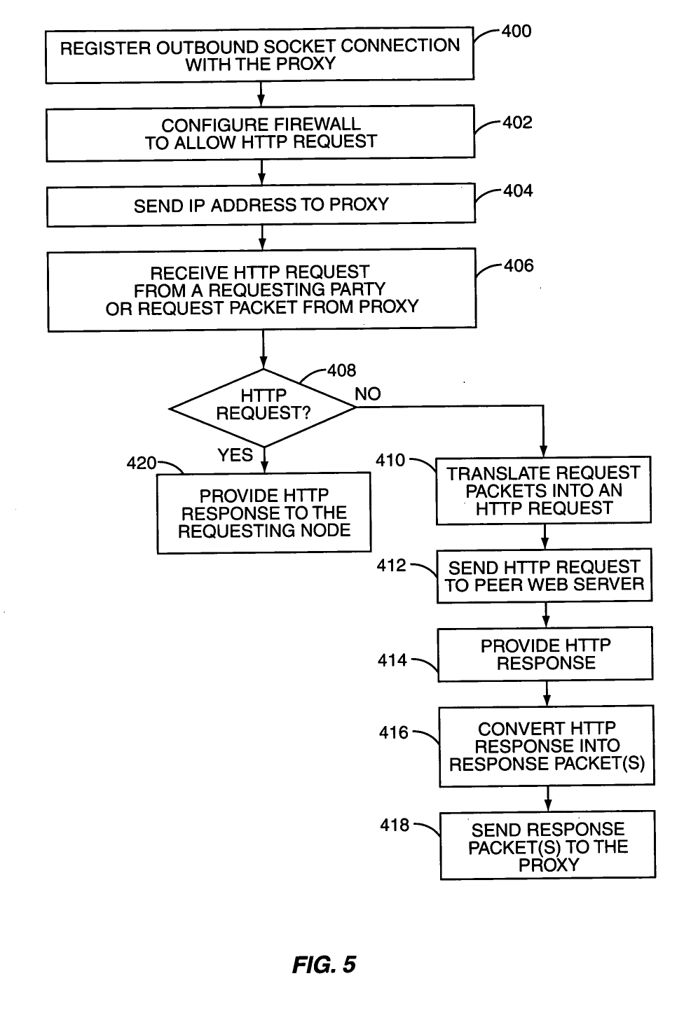

FIG. 5 is a flow chart illustrating the operation of the peer node 12A according to one embodiment of the present invention. When the peer node 12A comes online by connecting to the network 22 or enabling the peer node software 30, the peer node 12A first establishes, or registers, an outbound socket connection with the proxy server 14 (step 400). The firewall 24A is configured either manually or automatically to allow HTTP requests to be directed to the peer node 12A (step 402), and the IP address of the peer node 12A is sent to the proxy server 14 via the socket connection (step 404). In one embodiment, the outbound socket connection is established when the peer node 12A is first connected to the network 22 and the peer node software 30 is enabled and remains open until the peer node 12A is disconnected from the network 22 or the peer node software 30 is disabled. Further, the peer node 12A may send its IP address to the proxy server 14 periodically along with a keep-alive ping request. The firewall 24A may be configured only once when the peer node software 30 is first installed at the peer node 12A. Alternatively, the firewall 24A may be configured when the peer node 12A connects to the network 22 and the peer node software 30 is enabled.

The peer node 12A then receives either an HTTP request from a requesting node, which may be the guest node 16 or another peer node such as peer node 12B, or a request packet from the proxy server 14 via the socket connection (step 406). The peer node 12A may then determine if the request is an HTTP request (step 408). If the request is not an HTTP request but is a request packet from the proxy server 14, the peer node 12A, and specifically the peer node software 30, translates the request packet into an HTTP request (step 410) and sends the HTTP request to the web server 32 (step 412). The web server 32 then provides an HTTP response including the requested digital content 28 (step 414). The peer node software 30 then converts the HTTP response into one or more response packets (step 416) and sends the response packets to the proxy server 14 (step 418). Then, as discussed above, the proxy sever 14 converts the response packets into an HTTP response and sends the HTTP response to the requesting node.

If the request is an HTTP request from a requesting node, the peer node 12A may optionally perform some type of security check to determine if the HTTP request is valid such as checking to see if the HTTP request is for the digital content 28. If the HTTP request is valid, then the peer node 12A generates an HTTP response including the requested digital content 28 and provides the HTTP request to the requesting node (step 420).

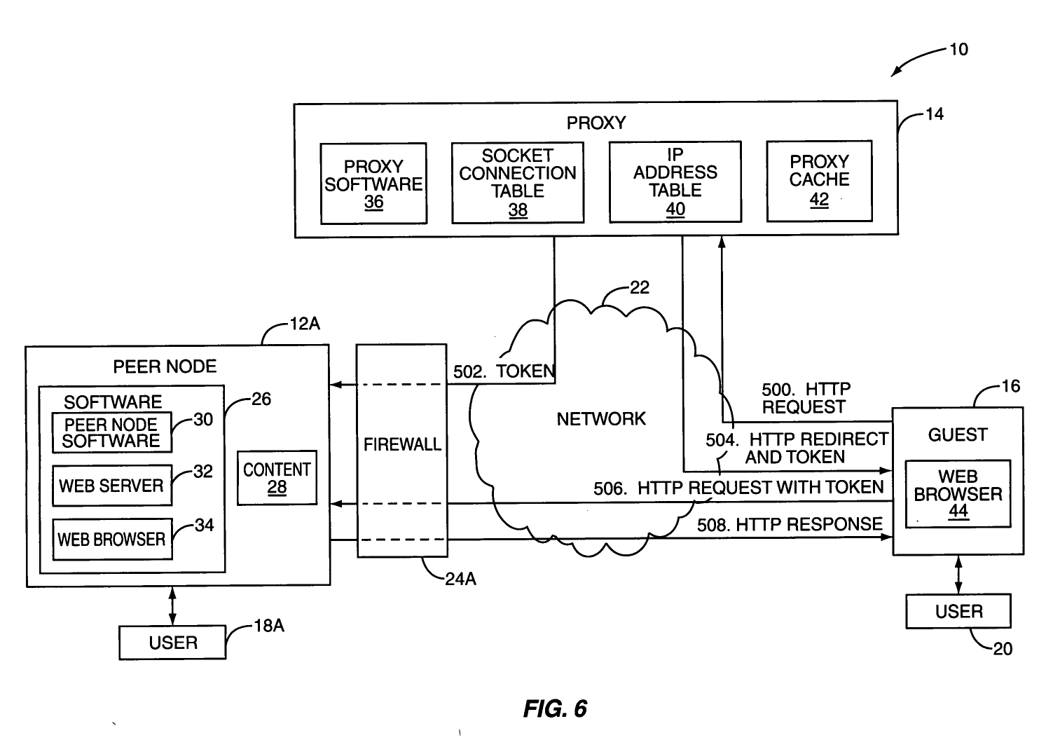

FIG. 6 illustrates a transfer of bandwidth rich digital content 28 according to another embodiment of the present invention. This embodiment is substantially the same as the embodiment illustrated in FIG. 3. However, in this embodiment, a unique single use token is generated by the proxy server 14 and used to provide increased security and/or to reduce the processing required by the peer node 12A in determining if a particular HTTP request is a valid request.

More specifically, the guest node 16 first sends an HTTP request for the digital content 28 residing at the peer node 12A (step 500). In this example, the digital content 28 is bandwidth rich content. In response to receiving the HTTP request, the proxy server 14 determines that the HTTP request is for bandwidth rich content. The proxy server 14 also determines the IP address of the peer node 12A and identifies the socket connection between the peer node 12A and the proxy server 14 using the IP address table 40 and the socket connection table 38, respectively.

The proxy server 14 then generates a unique single use token and sends the unique single use token to the peer node 12A via the socket connection between the peer node 12A and the proxy 14 (step 502). Next, the proxy server 14 constructs a URL for the digital content 28 at the peer node 12A having the unique single use token embedded therein. The unique single use token may be embedded in the URL as part of a query (ex. http:// . . . ?token=12345). Next, the proxy server 14 sends an HTTP redirect message including the URL to the guest node 16 (step 504).

Based on the HTTP redirect message, the guest node 16 sends an HTTP request including the URL having the unique single use token to the peer node 12A (step 506). The peer node 12A examines the HTTP request to determine if it includes the unique single use token. Since it does, the peer node 12A consumes the unique single use token, generates an HTTP response including the digital content 28, and sends the HTTP response to the guest node 16 (step 508). Note that HTTP requests received by the peer node 12A that do not include the unique single use token are ignored. Further, the unique single use token may be used only once. Thus, if, after receiving the HTTP request including the unique single use token, the peer node 12A receives another HTTP request including the same token, the peer node 12A ignores the request. By using the unique single use token, the processing required at the peer node 12A to determine if a particular HTTP request is a valid request is substantially reduced.

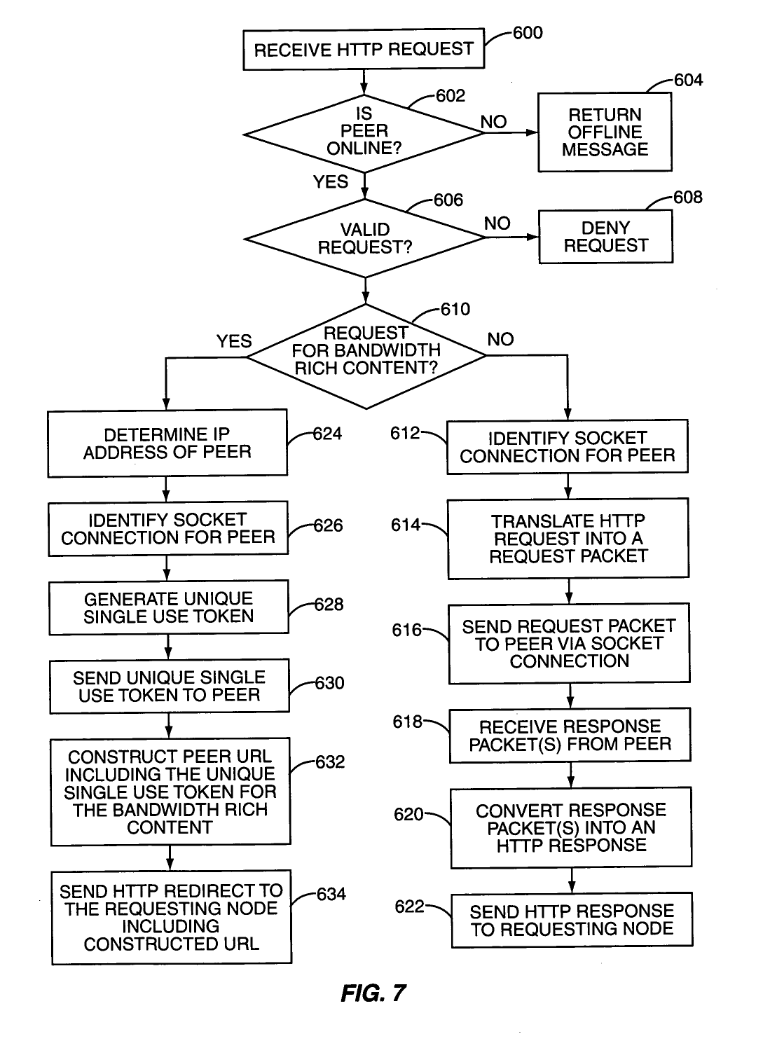

FIG. 7 is similar to FIG. 4 and is a flow chart illustrating the operation of the proxy server 14 according to the embodiment of the present invention shown in FIG. 6. In general, the proxy server 14 first receives an HTTP request from a requesting node (step 600). Note that prior to the proxy server 14 receiving the HTTP request, the peer node 12A establishes a socket connection with the proxy server 14 and provides its IP address to the proxy server 14, as discussed above.

After receiving the HTTP request, the proxy server 14 determines if the peer node 12A associated with the digital content 28 requested by the HTTP request is currently online (step 602). If the peer node 12A is not online, then the proxy server 14 returns an offline message to the requesting node (step 604). If the peer node 12A is currently online, then the proxy server 14 determines whether the HTTP request is a valid request (step 606). The HTTP request may be invalid if the HTTP request is for digital content that is not associated with the hybrid P2P system 10. If the HTTP request is not valid, then the request is denied (step 608).

If the HTTP request is valid, then the proxy server 14 determines if the HTTP request is for bandwidth rich content, as discussed above (step 610). If the HTTP request is for digital content 28 that is not bandwidth rich content, then the proxy server 14 identifies the socket connection that connects the peer node 12A to the proxy server 14 using the socket connection table 38 (step 612), translates the HTTP request into a request packet (step 614), and sends the request packet to the peer node 12A via the socket connection (step 616). Thereafter, the proxy server 14 receives response packets from the peer node 12A (step 618), converts the response packets into an HTTP response (step 620), and sends the HTTP response to the requesting node (step 622).

If the HTTP request is for digital content 28 that is bandwidth rich content, then the proxy server 14 determines the IP address of the peer node 12A (step 624) and identifies the socket connection connecting the peer node 12A to the proxy server 14 (step 626) using the IP address table 40 and the socket connection table 38, respectively. The proxy server 14 then generates a unique single use token (step 628), sends the unique single use token to the peer node 12A using the socket connection (step 630), constructs a URL for the bandwidth rich digital content 28 having the unique single use token embedded therein (step 632), and sends an HTTP redirect message including the constructed URL to the requesting node (step 634). For example, the token may be embedded within the URL as part of a query (ex. http:// . . . ?token=12345). Then, as discussed above, the requesting node uses the HTTP redirect message to send an HTTP request including the unique single use token directly to the peer node 12A to obtain the bandwidth rich digital content 28. As a result, the transfer of the digital content 28 by-passes the proxy server 14.

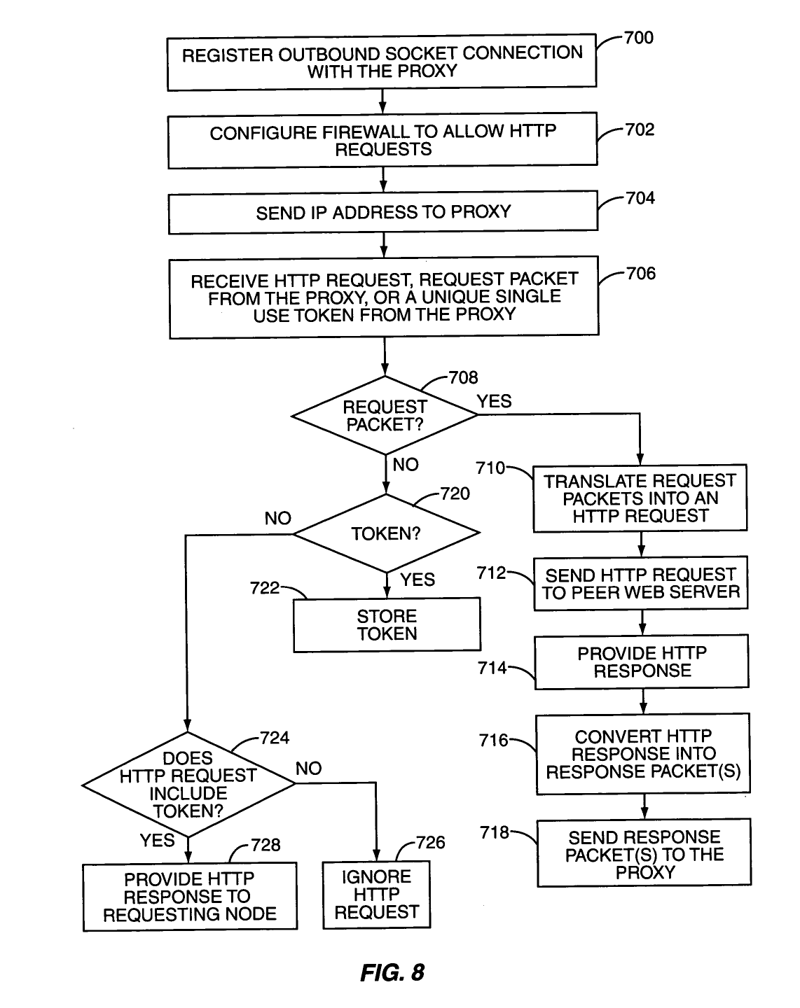

FIG. 8 is a flow chart illustrating the operation of the peer node 12A according to the embodiment of the present invention illustrated in FIG. 6. When the peer node 12A comes online by connecting to the network 22 or enabling the peer node software 30, the peer node 12A first establishes, or registers, an outbound socket connection with the proxy server 14 (step 700). The firewall 24A is configured either manually or automatically to allow HTTP requests to be directed to the peer node 12A (step 702), and the IP address of the peer node 12A is sent to the proxy server 14 via the socket connection (step 704). In one embodiment, the outbound socket connection is established when the peer node 12A is first connected to the network 22 and the peer node software 30 is enabled and remains open until the peer node 12A is disconnected from the network 22 or the peer node software 30 is disabled. Further, the peer node 12A may send its IP address to the proxy server 14 periodically along with a keep-alive ping request. The firewall 24A may be configured only once when the peer node software 30 is first installed at the peer node 12A. Alternatively, the firewall 24A may be configured when the peer node 12A connects to the network 22 and the peer node software 30 is enabled.

The peer node 12A then receives either an HTTP request from a requesting node, which may be the guest node 16 or another peer node such as peer node 12B; a request packet from the proxy server 14 via the socket connection; or a unique single use token from the proxy server 14 (step 706). The peer node 12A then determines if the request is a request packet from the proxy server 14 (step 708). If the request is a request packet from the proxy server 14, the peer node software 30 translates the request packet to an HTTP request (step 710) and sends the HTTP request to the web server 32 (step 712). The web server 32 then provides an HTTP response including the requested digital content 28 (step 714). The peer node software 30 then converts the HTTP response into one or more response packets (step 716) and sends the response packets to the proxy server 14 (step 718). Then, as discussed above, the proxy sever 14 converts the response packets into an HTTP response and sends the HTTP response to the requesting node.

Returning to step 708, if the request is not a request packet from the proxy server 14, the peer node 12A then determines if the received data is a unique single use token from the proxy server 14 (step 720). If so, the peer node 12A stores the unique single use token (step 722). It should be noted that the unique single use token may optionally have a predetermined time-out period defining a period of time for which the token is valid. After the time-out period has expired, the token may be discarded.

Returning to step 720, if the data received is not a token, then the data received is an HTTP request, and the peer node 12A determines if the HTTP request includes the unique single use token (step 724). If it does not, then the HTTP request is ignored (step 726). If the HTTP request does include the unique single use token, the peer node 12A generates an HTTP response including the requested digital content 28 and sends the HTTP response to the requesting node (step 728). After providing the HTTP response, the unique single use token is consumed or discarded such that it cannot be used to validate another HTTP request. Any subsequent HTTP requests will require a new unique single use token.

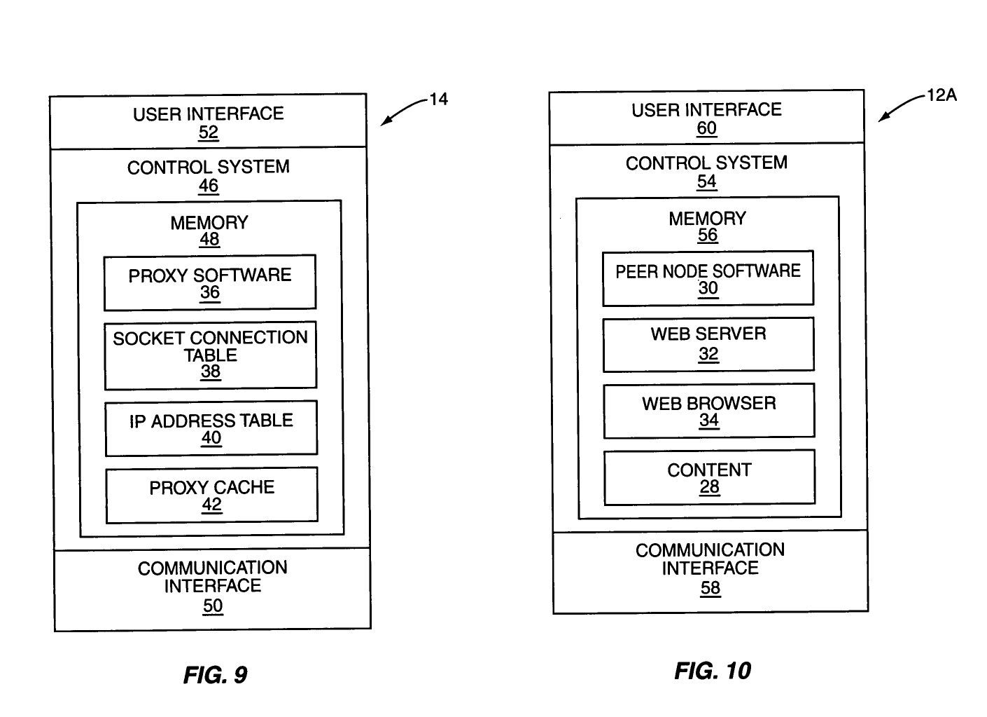

FIG. 9 illustrates a basic block diagram of an exemplary embodiment of the proxy server 14. The proxy server 14 may generally include a control system 46 having associated memory 48. The memory 48 may store the proxy software 36, the socket connection table 38, and the IP address table 40. In addition, the proxy cache 42 may be included within the memory 48. Alternatively, the proxy cache 42 may be memory separate from the memory 48. The proxy server 14 may also include a communication interface 50 for communicating with other network entities via the network 22 (FIG. 1). The communication interface 50 may also include an interface to various external devices. A user interface 52 may also be provided and include a keypad, mouse, display, and the like (not shown).

FIG. 10 illustrates a basic block diagram of an exemplary embodiment of the peer node 12A. The peer node 12A may generally include a control system 54 having associated memory 56. The memory 56 may store the peer node software 30, the web server 32, the optional web browser 34, and the digital content 28. The peer node 12A may also include a communication interface 58 for communicating with other network entities via the network 22 (FIG. 1). The communication interface 58 also may include an interface to various external devices such as a printer. A user interface 60 may also be provided and include a keypad, mouse, display, and the like (not shown).

The present invention provides substantial opportunity for variation without departing from the spirit or scope of the present invention. For example, the flow charts in FIGS. 4, 5, 7, and 8 are merely exemplary. Variations will be apparent to one having ordinary skill in the art upon reading this disclosure. Also, although the description herein describes the present invention with respect to a peer-to-peer network, the present invention is equally applicable to any system where digital content is provided from a web server to a requesting node via a proxy server.

Those skilled in the art will recognize improvements and modifications to the preferred embodiments of the present invention. All such improvements and modifications are considered within the scope of the concepts disclosed herein and the claims that follow.

What is claimed is:

1. A proxy server for a hybrid peer-to-peer system comprising:
a) a communication interface coupled to a network; and
b) a control system adapted to:
i) receive a first request for digital content residing at a first node from a requesting node via the communication interface; and
ii) redirect the requesting node to the first node if the digital content is bandwidth rich content such that a transfer of the digital content from the first node to the requesting node by-passes the proxy server.

2. The proxy server of claim 1 wherein if the digital content is not bandwidth rich content, the control system is further adapted to obtain the digital content from the first node and provide the digital content to the requesting node.

3. The proxy server of claim 1 wherein the control system is further adapted to:
determine a type of the digital content; and
determine whether the type of the digital content is one of at least one predetermined type associated with bandwidth rich content, thereby determining whether the digital content is bandwidth rich content.

4. The proxy server of claim 1 wherein the control system is further adapted to communicate with the first node via the communication interface to determine whether the digital content is bandwidth rich content.

5. The proxy server of claim 1 wherein the control system is further adapted to request a size of the digital content from the first node via the communication interface and determine whether the digital content is bandwidth rich content based on the size of the digital content.

6. The proxy server of claim 1 wherein the control system is further adapted to send a request to the first node for a determination of whether the digital content is bandwidth rich content, wherein the first node determines whether the digital content is bandwidth rich content based on at least one attribute of the digital content selected from the group consisting of file size and type.

7. The proxy server of claim 1 wherein the first request is a first Hypertext Transfer Protocol (HTTP) request and, in order to redirect the requesting node to the first node, the control system is further adapted to:
determine an Internet Protocol (IP) address of the first node;
construct a Uniform Resource Locator (URL) for the digital content; and
provide an HTTP redirect message including the URL for the digital content to the requesting node via the communication interface.

8. The proxy server of claim 7 further comprising memory storing an IP address table storing an IP address for each of a plurality of web serving nodes including the first node, wherein the control system is further adapted to determine the IP address of the first node by retrieving the IP address of the first node from the IP address table.

9. The proxy server of claim 8 wherein, for each of the plurality of web serving nodes, the control system is further adapted to receive the IP address of the web serving node from the web serving node and store the IP address in the IP address table.

10. The proxy server of claim 9 wherein, for each of the plurality of web serving nodes, the control system is further adapted to receive the IP address of the web serving node from the web serving node periodically.

11. The proxy server of claim 9 wherein, for each of the plurality of web serving nodes, the control system is further adapted to receive the IP address of the web serving node from the web serving node via a pre-established socket connection between the web serving node and the proxy server.

12. The proxy server of claim 7 wherein the requesting node generates a second HTTP request based on the HTTP redirect message and provides the second HTTP request to the first node, and the first node provides the digital content to the requesting node in response to the second HTTP request.

13. The proxy server of claim 1 wherein the first request is a first HTTP request and, in order to redirect the requesting node to the first node, the control system is further adapted to:
generate a unique single use token;
provide the unique single use token to the first node;
determine an Internet Protocol (IP) address of the first node;
construct a Uniform Resource Locator (URL) for the digital content and including the unique single use token; and
provide an HTTP redirect message including the URL for the digital content to the requesting node via the communication interface.

14. The proxy server of claim 13 wherein the requesting node generates a second HTTP request including the URL based on the HTTP redirect message and provides the second HTTP request to the first node, and the first node examines the second HTTP request for the unique single use token and provides the digital content to the requesting node in response to the second. HTTP request if the second HTTP request includes the unique single use token.

15. The proxy server of claim 13 further comprising memory storing an IP address table including an IP address for each of a plurality of web serving nodes including the first node, wherein the control system is further adapted to determine the IP address of the first node by retrieving the IP address of the first node from the IP address table.

16. The proxy server of claim 15 wherein, for each of the plurality of web serving nodes, the control system is further adapted to receive the IP address of the web serving node from the web serving node and store the IP address in the IP address table.

17. The proxy server of claim 16 wherein, for each of the plurality of web serving nodes, the control system is further adapted to receive the IP address of the web serving node from the web serving node periodically.

18. The proxy server of claim 16 wherein, for each of the plurality of web serving nodes, the control system is further adapted to receive the IP address of the web serving node from the web serving node via a pre-established socket connection between the web serving node and the proxy server.

19. The proxy server of claim 13 wherein the first node establishes a socket connection with the proxy server prior to the proxy server receiving the first HTTP request and the control system is further adapted to provide the unique single use token to the first node via the socket connection.

20. The proxy server of claim 19 further comprising memory storing a socket connection table that, for each of a plurality of web serving nodes including the first node, includes indicia identifying a socket connection for communicating with the web serving node, and wherein the control system is further adapted to determine the socket connection for the first node using the socket connection table.

21. The proxy server of claim 1 wherein the first request is a first HTTP request and, if the digital content is not bandwidth rich content, the control system is further adapted to:
translate the HTTP request into a request message;
provide the request message to the first node via a pre-established socket connection;
receive at least one response packet including the digital content from the first node;
convert the at least one response packet into an HTTP response; and
provide the HTTP response to the requesting node.

22. The proxy server of claim 21 further comprising memory storing a socket connection table that, for each of a plurality of web serving nodes including the first node, includes indicia identifying a socket connection for communicating with the web serving node, and wherein the control system is further adapted to determine the socket connection for the first node using the socket connection table.

23. A method for providing digital content from a peer node in a hybrid peer-to-peer system to a requesting node comprising:
providing a proxy server communicatively coupled to a network;
receiving a first request for digital content residing at the peer node from the requesting node at the proxy server;
determining whether the digital content is bandwidth rich content; and
redirecting the requesting node to the peer node if the digital content is bandwidth rich content such that a transfer of the digital content from the peer node to the requesting node by-passes the proxy server.

24. The method of claim 23 further comprising obtaining the digital content from the first node and providing the digital content to the requesting node if the digital content is not bandwidth rich content.

25. The method of claim 23 wherein determining whether the digital content is bandwidth rich content comprises:
determining a type of the digital content; and
determining whether the type of the digital content is one of at least one predetermined type associated with bandwidth rich content, thereby determining whether the digital content is bandwidth rich content.

26. The method of claim 23 wherein determining whether the digital content is bandwidth rich content comprises:
retrieving a size of the digital content from the peer node; and
determining whether the digital content is bandwidth rich content based on the size of the digital content.

27. The method of claim 23 wherein determining whether the digital content is bandwidth rich content comprises:
sending a request to the peer node for a determination of whether the digital content is bandwidth rich content; and
determining at the peer node whether the digital content is bandwidth rich content based on at least one attribute of the digital content selected from the group consisting of file size and type.

28. The method of claim 23 wherein the first request is a first Hypertext Transfer Protocol (HTTP) request and redirecting the requesting node to the peer node comprises:
determining an Internet Protocol (IP) address of the peer node;
constructing a Uniform Resource Locator (URL) for the digital content; and
providing an HTTP redirect message including the URL for the digital content to the requesting node.

29. The method of claim 28 further comprising:
receiving the IP address of the peer node from the peer node; and
storing the IP address of the peer node in an IP address table in memory associated with the proxy server;
wherein determining the IP address of the peer node comprises retrieving the IP address of the peer node from the IP address table.

30. The method of claim 29 wherein receiving the IP address of the peer node comprises receiving the IP address of the peer node from the peer node via a pre-established socket connection connecting the peer node to the proxy server.

31. The method of claim 28 further comprising:
generating a second HTTP request at the requesting node based on the HTTP redirect message;
providing the second HTTP request from the requesting node to the peer node; and
providing the digital content from the peer node to the requesting node in response to the second HTTP request.

32. The method of claim 23 wherein the first request is a first HTTP request and redirecting the requesting node to the peer node comprises:
generating a unique single use token;
providing the unique single use token to the peer node;
determining an Internet Protocol (IP) address of the peer node;
constructing a Uniform Resource Locator (URL) having the unique single use token embedded therein for the digital content; and
providing an HTTP redirect message including the URL for the digital content to the requesting node.

33. The method of claim 32 further comprising:
generating a second HTTP request including the URL having the unique single use token at the requesting node based on the HTTP redirect message;
providing the second HTTP request to the peer node;
examining the second HTTP request for the unique single use token at the peer node; and
providing the digital content to the requesting node in response to the second HTTP request if the second HTTP request includes the unique single use token.

34. The method of claim 32 further comprising:
receiving the IP address of the peer node from the peer node; and
storing the IP address of the peer node in an IP address table in memory associated with the proxy server;
wherein determining the IP address of the peer node comprises retrieving the IP address of the peer node from the IP address table.

35. The method of claim 34 wherein receiving the IP address of the peer node comprises receiving the IP address of the peer node from the peer node via a pre-established socket connection connecting the peer node to the proxy server.

36. The method of claim 32 wherein the peer node establishes a socket connection with the proxy server and the control system is further adapted to provide the unique single use token to the peer node via the socket connection.

37. The method of claim 23 wherein the first request is a first HTTP request and, if the digital content is not bandwidth rich content, the method further comprises:
translating the HTTP request into a request message;
providing the request message to the peer node via a pre-established socket connection;
receiving at least one response packet including the digital content from the peer node at the proxy server;
converting the at least one response packet into an HTTP response; and
providing the HTTP response from the proxy server to the requesting node.
